(19) United States
(12) Patent Application Publication
(10) Pub. No.: US 2004/0218090 A1
(43) Pub. Date: Nov. 4, 2004

(54) Apparatus and method for operating day and night modes of monitoring camera by measuring brightness in no video signal interval

(75) Inventor: Hyuk Sub Kwon, Choongchungbuk-do (KR)

Correspondence Address: Ladas & Parry, 26 West 61st Street, New York, NY, 10023, US

(73) Assignee: KT & C CO., LTD.

(21) Appl. No.: 10/449,638

(22) Filed: May 29, 2003

(30) Foreign Application Priority Data
Apr. 30, 2003 (KR) 10-2003-0027751

(51) Int. Cl. H04N 5/222

(52) U.S. Cl. 348/370

(57) ABSTRACT

The present invention relates to an apparatus and method for operating a day and night mode of a monitoring camera by measuring a brightness in a no video signal interval which are implemented in a such a manner that when a control unit detects a non video signal interval from a video signal from a camera which photographs a photographing object zone, a state of the current lighting unit is set to an off state, and a measuring signal for operating a detection unit is outputted, and a brightness of the current photographing object is measured based on the detection signal from the detection unit, and it is judged whether the brightness of the current photographing object is above a critical value that it is not needed to operate the lighting, and when the brightness of the same is above a critical value, the mode is set to a day mode, and a control signal is generated for maintaining the current off state of the lighting unit and is outputted to the lighting unit, and when the brightness of the same is below a critical value, the mode is set to the night mode, and a control signal is generated for turning on the lighting unit and is outputted to the lighting unit.

### BACKGROUND OF THE INVENTION

1. Field of the Invention

The present invention relates to an apparatus and method for operating a day and night mode of a monitoring camera, and in particular to an apparatus and method for operating day and night modes by measuring brightness in non video signal zone which are capable of automatically controlling lighting for a day or night mode operation by measuring a brightness of a photographing object in no video signal interval in a driving operation of a camera.

2. Description of the Background Art

Recently, as a digital video instrument is widely used, various of small and light cameras are available and are used at home or for a security purpose or a monitoring field.

In particular, a certain security system like a monitoring camera, etc. is installed in a shopping center in which various products are sold to customers, and a museum in which art works and cultural things are displayed, a certain facility which needed to be controlled for a visitor, a large scale of parking lots, and a public facility for thereby performing a security monitoring and preventing a crime or robbery.

Therefore, more than at least one camera are installed in a zone which needs a monitoring in each business site or a public facility. A certain measurement is prepared for preventing a robbery of a product, item, etc. and a certain crime based on an image recorded by a camera. An image picture is recorded and used as a material for recognizing an accurate circumference when a robbery or crime occurs.

FIG. 1 is a view illustrating the construction of a security monitoring system using a conventional monitoring camera.

As shown therein, the security monitoring system using a conventional monitoring camera includes a camera 10 for photographing a photographing object zone, a detection unit 20 for detecting a brightness of a photographing object photographed using the camera 10 and outputting to a control unit 30, a control unit 30 which controls the entire driving operation of the camera 10, judges a day mode or night mode based on the brightness of a photographing object inputted from the detection unit 20, generates a control signal for turning off a lighting unit 40 in the day mode, outputs to the lighting unit 40, generates a control signal for turning on the lighting unit 40 in the night mode, and outputs to the lighting unit 40, a lighting unit 40 which is turned on and off based on an on and off control signal from the control unit 30, and a storing unit 50 for storing a video signal photographed by the camera and outputting a video signal based on a request of the control unit 30.

The operation of the security monitoring system using a conventional monitoring camera will be described. When the video signals photographed using the camera 10 with respect to a photographing object is stored in the storing unit 50, the control unit 30 judges whether the brightness of the photographing object inputted from the control unit 30 into the detection 20 is brighter or darker. Namely, it is judged whether the brightness of the current photographing object is below a critical value for operating the lighting unit 40 or above the same.

As a result of the judgment, if the brightness is above the critical value that it is not needed to operate the lighting unit 40, the control unit 30 sets the day mode, and checks whether the current lighting unit 40 is on or off state. If the lighting unit 40 is on state, a control signal is outputted to the lighting unit 40 for turning off the lighting unit 40. If the lighting unit 40 is off state, a control signal is outputted to the lighting unit 40 for maintaining the current state.

As a result of the judgment, the brightness of the photographing object is below the critical value that needs an operation of the lighting unit 40, the control unit 30 sets the night mode, and checks whether the current lighting unit 40 is on or off state. If the lighting unit 40 is off state, a control signal is outputted to the lighting unit 40 for turning on the lighting unit 40. If the lighting unit 40 is on state, a control signal is outputted to the lighting unit 40 for maintaining the current state.

However, in the conventional monitoring camera, since the detection unit and lighting unit are always operated even when the camera is not driven because there is not any motion in the photographing object zone, the life span of a corresponding device is largely decreased. When the lighting unit is on state, when measuring the brightness, a certain error may occur in the measurement of the brightness due to an interference of the lighting unit.

In addition, in the conventional monitoring camera, when operating the lighting unit by detecting the brightness of the photographing object, the lighting unit is turned on and off based on the critical value. Therefore, when the detection signal repeats critical point, the lighting unit unnecessarily repeats the on and off operations when converting the day and night modes. In the on and off processes of the lighting unit, it is impossible to implement a good quality video signal due to a flicking phenomenon of screen in a video signal photographed using the camera.

### SUMMARY OF THE INVENTION

Accordingly, it is an object of the present invention to provide an apparatus and method for operating a day and night mode of a monitoring camera by measuring a brightness in a non video signal interval which are capable of measuring a brightness of a photographing object in a no video signal interval in a camera driving operation, and automatically controlling a brightness for a day or night mode operation based on the measured brightness.

It is another object of the present invention to provide an apparatus and method for operating a day and night mode of a monitoring camera by measuring a brightness in a non video signal interval which are capable of adjusting an on and off operation of light below or above a certain range of a critical value and preventing a repeated on and off operation of a lighting unit even when the brightness of the photographing object repeats the critical point.

To achieve the above objects, there is provided an apparatus for operating a day and night mode of a monitoring camera by measuring a brightness in a no video signal interval which includes a camera for photographing a certain zone which is a photographing object in a day mode or a night mode in accordance with an external control, a detection unit for detecting a brightness of a photographing object in accordance with an external control, a control unit which controls an entire driving operation of the camera, sets a lighting to an off state when a non video signal interval is extracted from a video signal inputted from the camera, controls an operation of the detection unit, receives a detection signal with respect to the current photographing object, measures a brightness of the photographing object based on the detection signal from the detection unit, judges a day mode or a night mode, generates a control signal for maintaining the current off state of lighting when the mode is the day mode, and generates a control signal for turning on the off state lighting when the mode is the night mode, a lighting unit which is turned off or on in accordance with an on and off control signal from the control unit which turns off the lighting in accordance with a control of the control unit that checked the no video signal interval and sets the day mode or night mode based on a brightness measurement in the no video signal interval, and a storing unit for storing a video signal photographed by the camera in accordance with a control of the control unit and outputting a video signal based on a request of the control unit.

To achieve the above objects, there is provided a method for operating a day and night mode of a monitoring camera by measuring a brightness in a no video signal interval which includes the steps of (1) a step in which a control unit judged whether there is a no video signal interval in a video signal from a camera which photographs a photographing object zone, (2) a step in which when the no video signal interval is detected in the video signals from the camera, the control unit sets the state of the current lighting unit to an off state and outputs a measuring signal for operating the detection unit to the detection unit, (3) a step in which the control unit measures the brightness of the current photographing object based on a detection signal from the detection unit, (4) a step in which the control unit judges whether the brightness of the current photographing object measured is above a critical value that the operation of the lighting is not needed, (5) a step in which as a result of the judgment, when the brightness of the current photographing object is above the critical value that it is not needed to operate the lighting, the control unit sets the mode to a day mode, and generates a control signal for maintaining the current off state of the lighting unit, and the control signal is outputted to the lighting means, and (6) a step in which as a result of the judgment of the step (4), when the brightness of the current photographing object is below a critical value that it is needed to operate the lighting, the control unit sets the night mode and generates a control signal for turning on the lighting unit and outputs to the lighting unit.

### BRIEF DESCRIPTION OF THE DRAWINGS

The present invention will become better understood with reference to the accompanying drawings which are given only by way of illustration and thus are not limitative of the present invention, wherein;

FIG. 1 is a view illustrating the construction of a conventional monitoring camera;

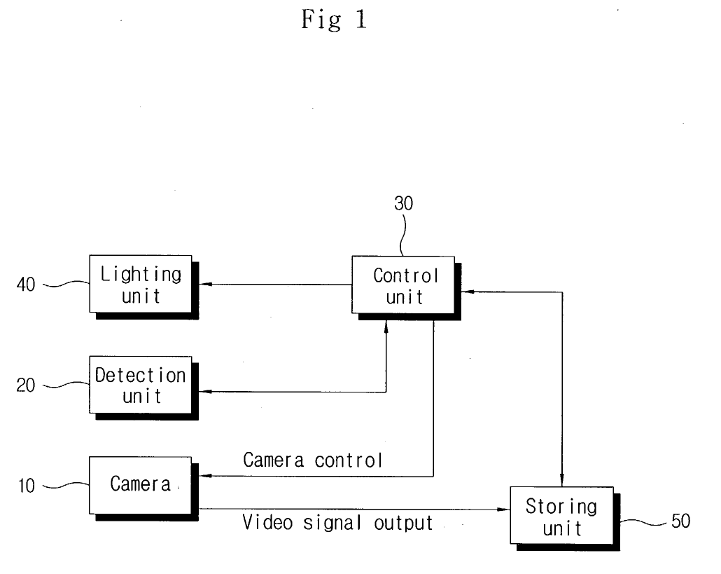

FIG. 2 is a view illustrating the construction of a day and night mode operation apparatus of a monitoring camera by measuring a brightness in a non video signal interval according to the present invention;

FIG. 3 is a view illustrating the construction of a control unit of FIG. 2; and

FIG. 4 is a flow chart of an operation procedure of a day and night mode operation method of a monitoring camera by measuring a brightness in a no video signal interval according to the present invention.

### DETAILED DESCRIPTION OF THE PREFERRED EMBODIMENTS

The apparatus and method for operating a day and night mode of a monitoring camera by measuring a brightness in a non video signal interval according to the present invention will be described with reference to the accompanying drawings.

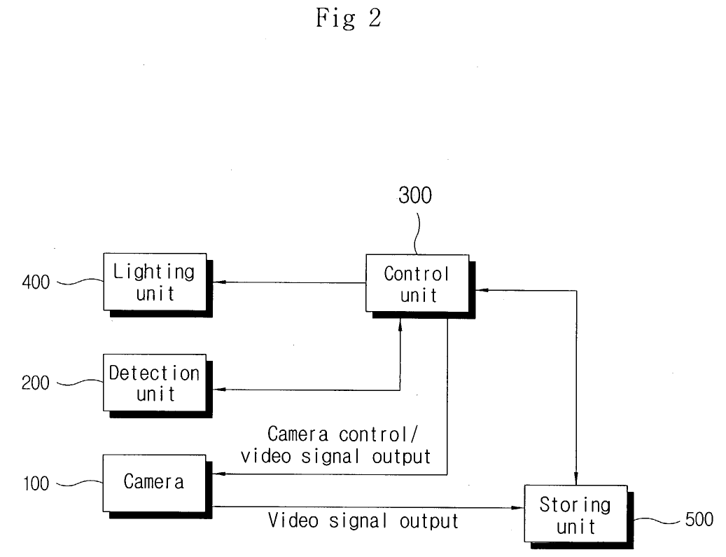

FIG. 2 is a view illustrating the construction of a day and night mode operation apparatus of a monitoring camera by measuring a brightness in a non video signal interval according to the present invention.

As shown therein, the camera 100 is installed in a zone that is a monitoring object, by more than at least one camera and is capable of photographing a photographing object in a day mode or night mode in accordance with a control of a control unit 300.

A detection unit 200 detects a brightness of a photographing object based on a control of the control unit 300 and outputs a detection result to the control unit 300. At this time, the detection unit 200 operates only in a non video signal interval among the video signals outputted from the camera 100 to the control unit 300.

The control unit 300 controls the entire operation of the camera 100. When a non video signal interval is extracted from the video signals inputted from the camera 100, and a lighting is set to an off state, and the operation of the detection unit 200 is controlled. The control unit 300 receives a detection signal with respect to the brightness of the current photographing object. The brightness of the photographing object is measured, and the day mode or night mode is judged. In the day mode, a control signal is generated for maintaining the current off state and is outputted to the lighting unit 400. In the night mode, a control signal for turning on the off state lighting and is outputted to the lighting unit 400.

At this time, the control unit 300 measures the brightness of the photographing object in the no video signal interval, and sets the day mode or night mode. As a result of the judgment, the lighting unit 400 is turned on or off, and the current lighting state is maintained until the no video signal interval is detected.

When the lighting unit 400 is driven based on a result of the measurement of the brightness based on the detection signal from the detection unit 200 in the no video signal interval, the control unit 300 may adjust the brightness of the lighting unit 400 based on multi steps.

In addition, in the control unit 300, it is possible to adjust the on and off operation of the lighting unit 400 based on the day mode or night mode change in a certain critical value range. Namely, the on and off operation of the lighting unit 400 is not controlled based on only the critical value, but is controlled below or above a certain range of the critical value, so that it is possible to prevent a repeat on and off operation of the lighting unit 400.

When the current lighting is on, the lighting unit 400 is turned off based on the off state setting of the control unit 300 which checked the no video signal interval, and the off state of the lighting is maintained or is turned on based on an on and off control signal from the control unit 300 which sets the day mode or night mode based on the measurement of the brightness in the non video signal interval. At this time, the lighting unit 400 is formed of a device such as a LED.

The storing unit 500 is adapted to store the video signals photographed using the camera 100 in accordance with a control of the control unit 300 and outputs a stored video signal based on a request of the control unit 300.

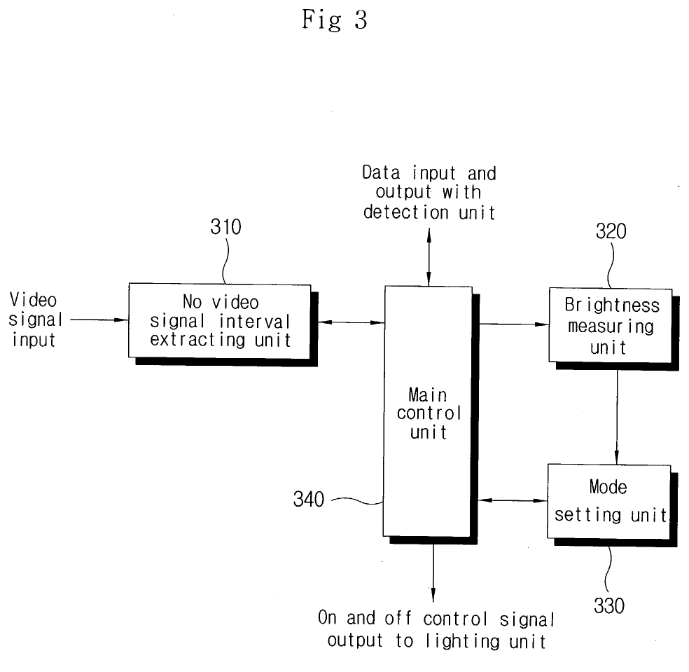

FIG. 3 is a view illustrating the construction of a control unit of FIG. 2.

As shown therein, a no video signal interval extracting unit 310 extracts a non video signal interval in the video signals from the camera 100 in accordance with a control of a main control unit 340 and outputs a result of the extraction to the main control unit 340.

A brightness measuring unit 320 measures the brightness of a photographing object based on the detection signal from the detection unit 200 in accordance with a control of the main control unit after a no video signal interval is extracted from the video signals from the camera 100 through the non video signal interval extracting unit 310 and outputs a result of the same to the main control unit 340.

When a non video signal interval is extracted from the video signals from the camera 100 through the no video signal interval extracting unit 310, the main control unit 340 checks the lighting state of the lighting unit 400 and sets the same to an off state and outputs an operation control signal to the detection unit 200 and outputs a detection signal with respect to the brightness of the photographing object from the detection unit 200 to the brightness measuring unit for thereby measuring the current brightness.

In addition, the mode setting unit 330 controls the setting of the day mode or night mode based on the brightness measured through the brightness measuring unit 320. In the case that the mode is set to the day mode by the mode setting unit 320, a control signal is outputted to the lighting unit 400 to maintain the current off state of the lighting unit 400. In the case that the mode is set to the night mode, a control signal is generated and is outputted to the lighting unit 400 for turning on the lighting unit 400.

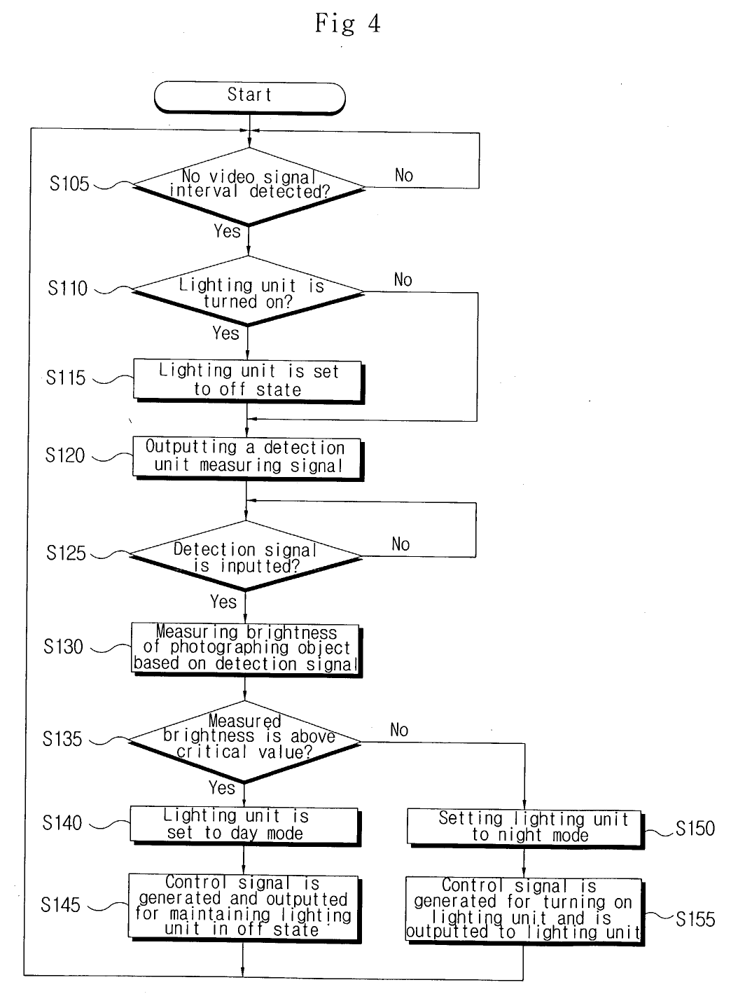

Next, an embodiment of the day and night mode operation method of the monitoring camera by measuring a brightness in a non video signal interval according to the present invention will be described with reference to FIG. 4.

FIG. 4 is a flow chart of an operation procedure of a day and night mode operation method of a monitoring camera by measuring a brightness in a no video signal interval according to the present invention.

As shown therein, the control unit 300 judges whether there is a non video signal interval in the video signal from the camera 100 which photographs the photographing object zone (S105). A this time, when there is a video signal, the control unit 300 maintain the lighting in an on and off state based on a day mode or night mode judgment set in the interval in which there is not a video signal.

As a result of the judgment, a no video signal interval is detected from the video signals from the camera 100, the control unit 300 judges whether the lighting unit 400 is an on state (S100). If the lighting unit 400 is on state, the lighting unit 400 is set to off state (S115).

As the non video signal interval is detected, after the lighting unit 400 is set to the off state, the control unit 300 outputs a control signal to the detection unit for operating the detection unit 200 (S120).

Thereafter, the control unit 300 judges whether a detection signal with respect to the brightness of the photographing object is inputted from the detection unit 200 (S125). When the detection signal is inputted from the detection unit 200, the brightness of the photographing object is measured based on a corresponding detection signal.

After the brightness of the photographing object is measured based on the detection signal from the detection means 200, the control unit 300 judges whether the brightness of the photographing object is above the critical value that the lighting is not needed (S135). Namely, it is judged whether the lighting unit 400 is operated or not operated based on the brightness of the current photographing object.

As a result of the judgment, if the brightness of the current photographing object is above the critical value that the lighting operation is not needed, the control unit 300 sets the mode to the day mode (S140) and generates a control signal for maintaining the lighting unit 400 in the current off state and outputs to the lighting unit 400.

However, as a result of the judgment of the step S135, when the brightness of the current photographing object is below the critical value that the lighting operation is needed, the control unit 300 sets the mode to the night mode (S150) and generates a control signal for turning on the off state lighting unit 400 and outputs to the lighting unit 400 (S155).

After the brightness of the photographing object is measured in the no video signal interval, and the mode is set to the day mode or night mode, and then the lighting unit 400 is turned on and of based on a result of the judgment, the current lighting state is maintained until the next non video signal interval is detected.

As described above, according to the apparatus and method for operating a day and night mode of the monitoring camera by measuring a brightness in a non video signal interval according to the present invention, the brightness of the photographing object is measured in the no video signal interval, and the on and off operation of the lighting unit is controlled for the day mode or night mode operation. Therefore, it is possible to maximize a prevention of a flicking phenomenon in a screen which may occur due to an on and off operation of the lighting unit during a photographing because the on and off operations of the lighting unit are controlled for the day mode or night mode operations, so that it is possible to obtain a good quality of video signals.

In addition, since the lighting unit does not operate before the lighting unit is turned on through the brightness measurement step in the non video signal interval, and the detection unit for measuring the brightness of the photographing object does not operate while there is a video signal, it is possible to extend the life span of various devices used for the lighting and detection, so that it is possible to decrease the cost needed for the maintenance.

Furthermore, since the lighting unit maintains an off state while the brightness of the photographing object is measured, it is possible to prevent any interference of the lighting unit. Therefore, it is possible to implement an original signal detection function, so that it is possible to accurately perform a brightness measurement of a photographing object.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An apparatus for operating a day and night mode of a monitoring camera by measuring a brightness in a no video signal interval, comprising:
a camera for photographing a certain zone which is a photographing object in a day mode or a night mode in accordance with an external control;
a detection means for detecting a brightness of a photographing object in accordance with an external control;
a control means which controls an entire driving operation of the camera, sets a lighting to an off state when a non video signal interval is extracted from a video signal inputted from the camera, controls an operation of the detection means, receives a detection signal with respect to the current photographing object, measures a brightness of the photographing object based on the detection signal from the detection means, judges a day mode or a night mode, generates a control signal for maintaining the current off state of lighting when the mode is the day mode, and generates a control signal for turning on the off state lighting when the mode is the night mode;
a lighting means which is turned off or on in accordance with an on and off control signal from the control means which turns off the lighting in accordance with a control of the control means that checked the no video signal interval and sets the day mode or night mode based on a brightness measurement in the no video signal interval; and
a storing means for storing a video signal photographed by the camera in accordance with a control of the control means and outputting a video signal based on a request of the control means.

2. The apparatus of claim 1, wherein said control means includes:
a no video signal interval extracting unit for extracting a no video signal interval from the video signal from the camera;
a brightness measuring unit which measured a brightness of a photographing object based on a detection signal from the detection means in accordance with an external control after the no video signal is extracted from the video signals from the camera by the no video signal extracting unit;
a mode setting unit which judges whether the brightness of the current photographing object is below a critical value that operates lighting based on the brightness of the photographing object measured by the brightness measuring unit in accordance with an external control or whether the same is above the critical value that does not need the operation of the lighting and sets a day mode or a night mode; and
a main control unit which checks a lighting state of the lighting means and set to the off state when a no video signal interval is extracted from the video signal inputted from the camera through the no video signal interval extracting unit, outputs an operation control signal to the detection means, outputs a detection signal with respect t the photographing object from the detection means to the brightness measuring unit, controls the current brightness, sets a day mode or a night mode based on the brightness measured by the brightness measuring unit in the mode setting unit, generates and outputs a control signal to the lighting means for maintaining the off state lighting means in the case that the mode is set to the day mode based on the setting of the day mode or night mode by the mode setting unit, and generates and outputs a control, signal to the lighting means for turning on the off state lighting means when the mode is set to the night mode.

3. The apparatus of claim 1, wherein said control means maintains the current lighting state until the next no video signal interval is detected after the control means measures a brightness of a photographing object in a no video signal interval, sets a day mode or night mode and turns on or off the lighting means based on a result of the judgment.

4. The apparatus of claim 1, wherein said control means adjusts the brightness of the lighting means based on a certain step when the control means drives the lighting means based on a result of the brightness measured based on the detection signal from the detection means in the no video signal interval.

5. The apparatus of claim 1, wherein said control means adjusts an on and off operation of the lighting in a certain range based on the change between the day mode or night mode.

6. A method for operating a day and night mode of a monitoring camera by measuring a brightness in a no video signal interval, comprising the steps of:
(1) a step in which a control means judged whether there is a no video signal interval in a video signal from a camera which photographs a photographing object zone;
(2) a step in which when the no video signal interval is detected in the video signals from the camera, the control means sets the state of the current lighting means to an off state and outputs a measuring signal for operating the detection means to the detection means;
(3) a step in which the control means measures the brightness of the current photographing object based on a detection signal from the detection means;
(4) a step in which the control means judges whether the brightness of the current photographing object measured is above a critical value that the operation of the lighting is not needed;
(5) a step in which as a result of the judgment, when the brightness of the current photographing object is above the critical value that it is not needed to operate the lighting, the control means sets the mode to a day mode, and generates a control signal for maintaining the current off state of the lighting means, and the control signal is outputted to the lighting means; and
(6) a step in which as a result of the judgment of the step (4), when the brightness of the current photographing object is below a critical value that it is needed to operate the lighting, the control means sets the night mode and generates a control signal for turning on the lighting means and outputs to the lighting means.

7. The apparatus of claim 2, wherein said control means maintains the current lighting state until the next no video signal interval is detected after the control means measures a brightness of a photographing object in a no video signal interval, sets a day mode or night mode and turns on or off the lighting means based on a result of the judgment.

8. The apparatus of claim 2, wherein said control means adjusts the brightness of the lighting means based on a certain step when the control means drives the lighting means based on a result of the brightness measured based on the detection signal from the detection means in the no video signal interval.

9. The apparatus of claim 2, wherein said control means adjusts an on and off operation of the lighting in a certain range based on the change between the day mode or night mode.
